(19) United States
(12) Patent Application Publication
(10) Pub. No.: US 2023/0219834 A1
(43) Pub. Date: Jul. 13, 2023

(54) TREATMENT OF NITROGEN COMPOUNDS IN SPENT CAUSTIC

(71) Applicant: Siemens Energy, Inc., Orlando, FL (US)

(72) Inventors: Philip A. Burclaff, Weston, WI (US); Bryan J. Kumfer, Ringle, WI (US)

(21) Appl. No.: 18/002,667

(22) PCT Filed: Jul. 1, 2021
(86) PCT No.: PCT/US2021/040040

§ 371 Date: Dec. 21, 2022

Related U.S. Application Data
(60) Provisional application No. 63/049,728, filed on Jul. 9, 2020.

(51) Int. Cl. C02F 11/08; C02F 1/72; C02F 1/74; B01J 23/755; B01J 23/46; B01J 21/08

(52) U.S. Cl. CPC C02F 11/08; C02F 1/725; C02F 1/74; B01J 23/755; B01J 23/462; B01J 21/08; C02F 2101/38

(57) ABSTRACT

Systems for treating wastewater containing organic nitrogen compounds are disclosed. The systems include a wet air oxidation unit having an oxidation zone, a catalytic zone, and a metal-based catalyst. Methods of treating wastewater containing organic nitrogen compounds are also disclosed. The methods include contacting the wastewater with an oxidant to produce a mixed liquor, contacting the mixed liquor with a metal-based catalyst to catalyze ammonia and produce a gas containing nitrogen and a liquid effluent containing nitrogen. Methods of retrofitting a wet air oxidation unit including providing a metal-based catalyst are also disclosed. Methods of facilitating treatment of wastewater in a wet air oxidation unit including providing a metal-based catalyst are also disclosed.

### FIELD OF TECHNOLOGY

The disclosure relates generally to chemical treatment systems and processes, and more particularly to systems and processes for treating nitrogen compounds in spent caustic.

### SUMMARY

In accordance with one aspect, there is provided a system for treating wastewater containing organic nitrogen compounds. The system may comprise a wet air oxidation unit having an inlet fluidly connectable to a source of the wastewater containing organic nitrogen compounds, a gas outlet, and a liquid effluent outlet. The wet air oxidation unit may comprise an oxidation zone fluidly connectable to a source of an oxidant, a catalytic zone downstream from the oxidation zone, and a metal-based catalyst configured to catalyze a conversion reaction of ammonia to nitrogen, positioned within the catalytic zone.

The system may further comprise at least one ammonia sensor positioned downstream from at least one of the gas outlet and the liquid effluent outlet.

In some embodiments, the metal-based catalyst may comprise a porous substrate coated with a group VIIIB metal.

The group VIIIB metal may be at least one of ruthenium, nickel, palladium, and platinum.

In some embodiments, the porous substrate may be mechanically stable at a pH of 8.5 or greater.

The porous substrate may comprise a silica-type material.

In some embodiments, a volume of the oxidation zone may be at least about twice a volume of the catalytic zone.

In some embodiments, the oxidation zone and the catalytic zone may be within a single vessel.

In some embodiments, the oxidation zone may be within a first vessel and the catalytic zone may be within a second vessel fluidly connected to the first vessel.

The wastewater containing organic nitrogen compounds may be a spent caustic solution.

In some embodiments, the spent caustic solution may be a refinery spent caustic solution

In accordance with another aspect, there is provided a method of treating wastewater containing organic nitrogen compounds. The method may comprise contacting the wastewater with an oxidant to oxidize a target percentage of the organic nitrogen compounds and produce a mixed liquor comprising ammonia. Th method may comprise contacting the mixed liquor with a metal-based catalyst to convert a target percentage of the ammonia to nitrogen and produce a gas comprising nitrogen and a liquid effluent comprising nitrogen. The method may comprise releasing the gas comprising nitrogen.

The method may comprise measuring at least one of a concentration of ammonia in the gas and a concentration of ammonia in the liquid effluent.

The method may comprise replacing or regenerating the metal-based catalyst responsive to the measurement of ammonia in at least one of the gas and the liquid effluent being greater than a pre-determined threshold concentration.

In some embodiments, the threshold concentration of ammonia in the liquid effluent may be less than 300 ppm. The threshold concentration of ammonia in the gas may be less than 250 ppm.

In some embodiments, the target percentage of the ammonia to be converted may be at least 95%.

The method may further comprise measuring a pH value of the mixed liquor.

The method may further comprise directing the liquid effluent to a biological treatment operation.

In accordance with another aspect, there is provided a method of retrofitting a wet air oxidation unit having an inlet fluidly connected to a source of a wastewater containing organic nitrogen compounds, a gas outlet, and a liquid effluent outlet. The method may comprise designating an oxidation zone of the wet air oxidation unit, fluidly connected to a source of an oxidant. The method may comprise designating a catalytic zone of the wet air oxidation unit downstream from the oxidation zone. The method may comprise providing a metal-based catalyst configured to catalyze a conversion reaction of ammonia to nitrogen. The method may comprise positioning the metal-based catalyst within the catalytic zone.

In some embodiments, the method may comprise providing a vessel to be designated as the catalytic zone and fluidly connecting the vessel to the oxidation zone.

The method may comprise providing at least one ammonia sensor and positioning the at least one ammonia sensor downstream from at least one of the gas outlet and the liquid effluent outlet.

The method may comprise programming the sensor or a controller operably connected to the sensor to alert a user responsive to measuring a concentration of ammonia in at least one of the gas and the liquid effluent greater than a pre-determined threshold concentration.

In accordance with yet another aspect, there is provided a method of facilitating treatment of wastewater containing organic nitrogen compounds in a wet air oxidation unit. The method may comprise providing a metal-based catalyst configured to catalyze a conversion reaction of ammonia to nitrogen. The method may comprise positioning the metal-based catalyst within a catalytic zone of the wet air oxidation unit.

In some embodiments, the method may comprise providing the wet air oxidation unit having an inlet, a gas outlet, and a liquid effluent outlet.

The method may comprise designating an oxidation zone of the wet air oxidation unit fluidly connected to a source of an oxidant, and designating a catalytic zone of the wet air oxidation unit downstream from the oxidation zone.

The method may comprise fluidly connecting the inlet of the wet air oxidation unit to a source of the wastewater containing organic nitrogen compounds.

The method may comprise instructing a user to operate the wet air oxidation unit to convert at least 95% of the ammonia to nitrogen in the catalytic zone.

In some embodiments, the method may comprise providing at least one ammonia sensor and positioning the at least one ammonia sensor downstream from at least one of the gas outlet and the liquid effluent outlet.

The method may comprise replacing or regenerating the metal-based catalyst responsive to the at least one ammonia sensor measuring a concentration of ammonia in at least one of the gas and the liquid effluent greater than a pre-determined threshold concentration.

In some embodiments, the threshold concentration of ammonia in the liquid effluent may be less than 300 ppm. The threshold concentration of ammonia in the gas may be less than 250 ppm.

The disclosure contemplates all combinations of any one or more of the foregoing aspects and/or embodiments, as well as combinations with any one or more of the embodiments set forth in the detailed description and any examples.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a wet air oxidation process flow diagram, according to one embodiment;

FIG. 2 is a schematic drawing of a system for treatment of wastewater, according to one embodiment;

FIG. 3 is a schematic drawing of a system for treatment of wastewater, according to one embodiment;

FIG. 4 is a schematic drawing of a system for treatment of wastewater, according to one embodiment;

FIG. 5 is a schematic drawing of a system for treatment of wastewater, according to one embodiment; and

FIG. 6 is a schematic diagram of a laboratory autoclave system for bench-scale wet air oxidation, according to one embodiment.

### DETAILED DESCRIPTION

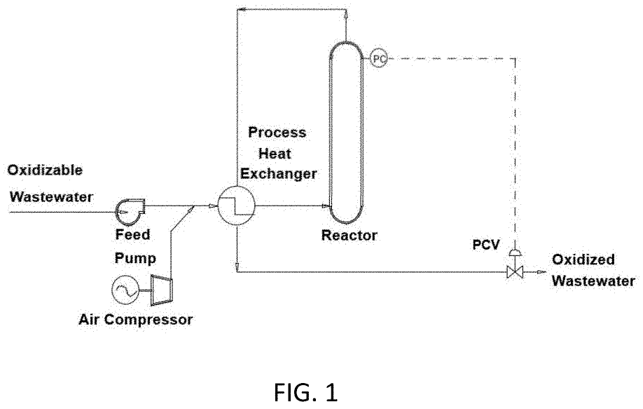

Wet air oxidation (WAO) is a process for treating wastewater that typically includes oxidizing suspended or dissolved material in process streams. The treatment may involve aqueous phase oxidation of undesirable constituents by an oxidizing agent, for example, molecular oxygen from an oxygen-containing gas, at elevated temperatures and pressures. The treatment may convert organic contaminants to carbon dioxide, water, and biodegradable short chain organic acids, such as acetic acid. Inorganic constituents including sulfides, mercaptides, and cyanides may also be oxidized. FIG. 1 is a flow diagram of an exemplary WAO process. WAO may be used in a wide variety of applications to treat process streams for subsequent discharge, in-process recycle, or as a pre-treatment step for a conventional biological treatment plant.

Spent caustic is a waste industrial caustic solution that has become exhausted. Spent caustic often contains sodium hydroxide or potassium hydroxide, water, and contaminants. Refinery spent caustics are associated with the processing of gasoline, kerosene, jet fuel, or liquefied petroleum gas. In refinery streams, sulfides and organic contaminants are removed from the product streams into the caustic phase. Sodium hydroxide is consumed, and the resulting wastewater is the refinery spent caustic. Refinery spent caustics are contaminated with sulfides, carbonates, and organic acids.

Spent caustic, for example, refinery spent caustic, often contains nitrogen compounds such as amines and diethanol urea. Spent caustic streams containing nitrogen compounds are difficult to treat in conventional wastewater treatments. When treated with WAO, the organic nitrogen is oxidized and converted to ammonia, which is discharged as off gas and ammonia liquid. Further treatment may require scrubbing ammonia from the off gas and treating the liquid ammonia effluent by pH control and biological treatment. For example, a sulfuric acid scrubber may be required to remove ammonia from the off gas, creating an ammonium sulfate solution that requires even further treatment. The pH control may require chemical addition to the liquid effluent. The biological treatment unit may require a re-design to treat the ammonia liquid effluent, since conventional biological treatment plants may be undersized for such treatment. Even if a stripper is employed to remove the ammonia from the liquid effluent before being transferred to the biological treatment unit, the stripping process produces an ammonium sulfate stream that requires further treatment or specialized disposal. Thus, conventional methods of treating spent caustic comprising nitrogenous compounds with WAO are complex.

Catalysts, for example, metal-based catalysts, may be used in water treatment to destroy organic compounds. In WAO, metal-based catalysts are conventionally employed to catalyze the WAO oxidation reaction of organic compounds. The process is generally referred to as catalytic wet air oxidation (CWAO). CWAO may be used to reduce the energy requirement or period of time of operation. For example, a CWAO unit may be operated at lower temperatures and/or shorter induction times to achieve a substantially similar oxidation treatment of organic compounds. Applying conventional CWAO treatment to WAO treatment of wastewater having nitrogen compounds will generally catalyze the conversion of organic nitrogen into ammonia. However, the produced ammonia in the off gas and liquid effluent may still require treatment as described above.

The systems and methods described herein employ metal-based catalysts to treat the produced ammonia, reducing or eliminating ammonia in the off gas and liquid effluent. In certain embodiments, the systems and methods disclosed herein employ metal-based catalysts to treat the ammonia in a catalytic zone within a WAO treatment unit. Briefly, the oxidation reaction may oxidize organic nitrogen compounds, converting the nitrogen to ammonia. The oxidation reaction may be catalyzed or not catalyzed. A catalytic reaction may then catalyze the ammonia conversion to nitrogen gas, which may be safely discharged from the system. Thus, the catalytic reaction is employed for treatment of nitrogen compounds.

Accordingly, the systems and methods described herein may reduce or eliminate ammonia in the off gas and/or liquid effluent, reducing post-treatment requirements such as off gas scrubbing and chemical addition to the liquid effluent.

In accordance with one aspect, there is provided a method of treating wastewater containing nitrogen compounds. Wastewaters which may be treated by the methods disclosed herein generally include organic nitrogen compounds. The wastewater may comprise a spent caustic solution. For instance, the wastewater may comprise a refinery spent caustic solution.

The spent caustic solution, e.g., refinery spent caustic solution, may contain organic nitrogen compounds such as amines and urea compounds. Exemplary organic nitrogen compounds include urea, diethanol urea, and monoethanolamine (MEA). Other organic nitrogen compounds may be present in the spent caustic solution.

The concentration of organic nitrogen in the wastewater may be at least about 500 mg/mL (as N) and up to 10,000 mg/mL (as N). For example, the concentration of organic nitrogen in the wastewater may be between 500 mg/mL (as N) and 1,000 mg/mL (as N), between 1,000 mg/mL (as N) and 3,000 mg/mL (as N), between 3,000 mg/mL (as N) and 5,000 mg/mL (as N), or between 5,000 mg/mL (as N) and 10,000 mg/mL (as N).

In addition to the organic nitrogen compounds, the spent caustic stream may contain sulfides, mercaptides, naphthenic acids, phenol, and other contaminants. For example, typical spent caustic effluent contains about 4-12% sodium hydroxide (NaOH) by weight, although this could be as low as 1% or 2%.

As used in this disclosure, the term “refinery spent caustic” refers to spent caustic generated in the operation of equipment and processes such as those which may be found at a petroleum refinery. Refinery spent caustic may have high levels of chemical oxygen demand (COD), in some cases between about 400,000 mg/L and 500,000 mg/L or more. Refinery spent caustic may contain one or more of naphthenic spent caustics, cresylic spent caustics, and sulfidic spent caustics. In certain embodiments, the refinery spent caustic may be diluted to a COD level of between about 50,000 mg/L and 150,000 mg/L.

The composition of a typical refinery spent caustic stream contains sulfides (e.g., 0.5-4% as sulfur) and mercaptides (e.g., 0.1-4%). However, naphthenic spent caustic typically contains mostly naphthenic acids (e.g., as high as 15%, mostly in diesel) and minimal sulfide. Cresylic spent caustic stream is typically rich in phenols, cresols, and other organic acids. Phenol content can be as high as 2000 ppm.

The methods may comprise contacting the wastewater with an oxidant to oxidize a target percentage of organic contaminants in the wastewater and produce a mixed liquor. For instance, the methods may comprise contacting the wastewater with an amount of oxidant effective to oxidize the target percentage of organic contaminants. In some embodiments, the methods may comprise contacting the wastewater with an oxidant for a period of time sufficient to oxidize the target percentage of organic contaminants. The target percentage of organic contaminants to be oxidized may be at least about 70%, at least about 75%, at least about 80%, at least about 85%, at least about 90%, or at least about 95%.

The oxidation reaction may be performed in a WAO unit under appropriate oxidation conditions. Systems for treating wastewater comprising a wet air oxidation unit are disclosed herein. The WAO unit may have an inlet fluidly connectable to a source of the wastewater, a gas outlet, and a liquid effluent outlet. The WAO unit may have an inlet fluidly connectable to a source of an oxidant. The WAO reactor may provide sufficient retention time to allow the oxidation to approach a desired oxidation treatment or reduction in COD. The WAO unit may be sized to treat about 1-15 m³/hr of wastewater. In some embodiments, the WAO unit may be sized to treat about 5-10 m³/hr of wastewater.

The WAO treatment process may use molecular oxygen contained in air or any oxygen containing gas as the oxidant. The process may operate at elevated temperatures and super-atmospheric pressures. Some WAO systems may operate at temperatures and pressures which may range from about 120° C. (248° F.) to 320° C. (608° F.) and 760 kPa (110 psig) to 21,000 kPa (3000 psig), respectively. Some systems may operate at temperatures as high as the critical temperature of water, 374° C. Other systems may operate at even higher temperatures wherein the fluid being treated in the vessel may exist at least in part as a supercritical fluid. The utilization of higher treatment temperatures may reduce the amount of time required for a desired level of treatment. Thus, the WAO system may comprise a temperature control subsystem configured to control temperature of the liquid mixtures.

In some systems the pressure of the reaction vessel may be controlled to a specific set point. The WAO system may comprise a pressure control subsystem configured to control pressure of the liquid mixtures. In some systems the pressure of the reaction vessel may attain a certain level as a result of the heating of the fluid being treated and the atmosphere within the sealed vessel.

In some WAO systems the wastewater to be treated is pumped up to pressure by a high-pressure feed pump. Thus, the system may comprise a pump delivering the wastewater to the WAO unit. The source of the wastewater may be fluidly connected to the source of the oxidant. For example, the oxidant may be injected into the pressurized wastewater. The oxidant/liquid mixture may be preheated to the desired reactor inlet temperature. The mixture may be introduced into a reactor vessel where the majority of oxidation may take place. Alternatively, or in addition, the source of the oxidant may be fluidly connected directly to the oxidation reaction vessel. For example, the oxidant may be injected directly into the WAO oxidation reaction vessel.

The WAO reactor may provide sufficient retention time to allow the oxidation to approach a desired oxidation treatment or reduction in COD. The mixed liquor (oxidized wastewater) may have a COD level of at least 70-95% less than the wastewater. For example, the mixed liquor may have a COD level of between about 5,000 mg/L to 100,000 mg/L.

The methods may comprise measuring pH of the wastewater or mixed liquor. The methods may comprise controlling pH of the wastewater or mixed liquor. In certain embodiments, the WAO system may include one or more pH sensors. The WAO system may include a subsystem allowing the pH of the wastewater be adjusted. A pH adjuster, such as an acid or a base, may be added to the wastewater before introduction into the WAO reactor vessel, or into the reactor vessel itself. The pH adjuster may be added in an amount effective to control pH to be below 12, for example, below 11, below 10, or below 9.

The methods disclosed herein comprise contacting the mixed liquor (oxidized wastewater) with a metal-based catalyst to convert a target percentage of the ammonia in the mixed liquor to nitrogen. Catalytic treatment of ammonia in the mixed liquor may significantly reduce the amount of ammonia discharged in the off gas and liquid effluent. Instead, the catalytic reaction may produce a gas and liquid effluent comprising a significant amount of nitrogen. In accordance with certain embodiments, the off gas may have a composition suitable for release to the environment. In some embodiments, the method may comprise releasing the gas comprising nitrogen. The liquid effluent may have a composition suitable for biological treatment. In some embodiments, the method may comprise directing the liquid effluent to a biological treatment operation.

The catalytic reaction may be performed under conditions selected to convert a pre-determined target percentage of ammonia into nitrogen. For example, the methods may comprise contacting the mixed liquor with a catalyst having a composition effective to convert the target percentage of ammonia. In some embodiments, the methods may comprise contacting the mixed liquor with the catalyst for a period of time sufficient to convert the target percentage of ammonia. The target percentage of ammonia to be converted may be at least about 80%, at least about 85%, at least about 90%, at least about 95%, at least about 99%, or at least about 99.99%.

The off gas may have a composition suitable for release to the environment. The off gas may be more than 85%, more than 87%, more than 90%, or more than 92% nitrogen. The off gas may be less than 0.1% carbon monoxide and less than 0.5% carbon dioxide. The off gas may have less than 50 ppm methane, for example, less than 40 ppm or less than 30 ppm. The off gas may have less than 85 ppm total hydrocarbon (THC), for example, less than 60 ppm, less than 50 ppm, or less than 10 ppm THC.

The liquid effluent may have a composition suitable for biological treatment. The process may destroy at least 80%, at least 90%, at least 92%, or at least 95% Total Kjeldahl nitrogen (TKN) from the mixed liquor, as detected in the liquid effluent.

The WAO unit may be configured to treat the wastewater by the methods disclosed herein. In particular, the WAO unit may be configured to enable oxidation of the organic nitrogen compounds into ammonia and catalytic conversion of the produced ammonia into nitrogen. For instance, the WAO unit may comprise an oxidation zone fluidly connectable to the source of the wastewater and the source of the oxidant, where a majority of oxidation may take place. The WAO unit may comprise a catalytic zone, downstream from the oxidation zone, where a majority of the catalytic conversion may take place. The catalytic zone may contain a metal-based catalyst configured to catalyze the conversion reaction of ammonia into nitrogen.

The oxidation zone and the catalytic zone may be housed in a single vessel. An upstream portion of the WAO vessel may be designated as the oxidation zone. Wastewater and oxidant may be combined towards an inlet of the WAO vessel. WAO units are typically arranged and operated as once-through treatment units. As the wastewater and oxidant flow through the oxidation zone, the organic contaminants become oxidized, producing the mixed liquor. A downstream portion of the WAO vessel may be designated as the catalytic zone. The mixed liquor comprising ammonia may come into contact with the metal-based catalyst in the downstream portion of the WAO vessel. As the mixed liquor flows through the catalytic zone, the ammonia may be converted to nitrogen, producing the nitrogen gas and nitrogen-containing liquid effluent.

The oxidation zone and the catalytic zone may be housed in separate vessels. For example, the oxidation zone may be within a first vessel of the WAO unit and the catalytic zone may be within a second vessel of the WAO unit. The oxidation vessel and the catalytic vessel may be fluidly connected to each other, with the catalytic vessel being downstream from the oxidation vessel.

The oxidation vessel may have one or more inlets for receiving the wastewater and the oxidant. For example, the oxidation vessel may have an inlet for receiving a wastewater and oxidant mixture. The oxidation vessel may have a separate inlet for receiving oxidant. The oxidation vessel may have a separate inlet for receiving wastewater. The oxidation vessel may have an outlet for discharging mixed liquor. The oxidation vessel may have an outlet for discharging off gas.

The catalytic vessel may contain the metal-based catalyst. The catalytic vessel may have an inlet for receiving the mixed liquor from the oxidation vessel. The catalytic vessel may have an outlet for discharging off gas. The catalytic vessel may have an outlet for discharging liquid effluent. In some embodiments, the liquid effluent outlet may be fluidly connectable to a biological treatment or other post-treatment unit.

Each of the oxidation zone and the catalytic zone may be dimensioned to achieve a target reaction rate of oxidation and conversion of ammonia to nitrogen, respectively. The dimensions of the oxidation zone and the catalytic zone may be selected based on composition and flow rate of the wastewater to be treated. In certain embodiments, the oxidation zone has a volume that is at least one to four times the volume of the catalytic zone. For instance, the oxidation zone and the catalytic zone may have a substantially equivalent volume. The oxidation zone may have a volume that is at least about twice a volume of the catalytic zone. The oxidation zone may have a volume that is at least about three times a volume of the catalytic zone. The oxidation zone may have a volume that is at least about four times a volume of the catalytic zone.

The catalytic zone may contain the metal-based catalyst. For instance, the metal-based catalyst may be positioned to contact the mixed liquor within the catalytic zone. The metal-based catalyst may be fastened or otherwise held in place within the catalytic zone. For example, the metal-based catalyst may be positioned within a fluidly accessible chamber within the catalytic zone. The metal-based catalyst may be reversibly removable from the WAO unit. In some embodiments, the metal-based catalyst may be mounted on or in a reversibly removable support structure. In some embodiments, the metal-based catalyst may be in the form of a packed bed structure or column. The removable metal-based catalyst may be capable of being replaced and/or regenerated after it becomes spent.

The metal-based catalyst may comprise a porous substrate coated with the metal catalyst material. The metal catalyst material may be any material configured to catalyze the conversion reaction of ammonia into nitrogen under the reaction conditions. In certain embodiments, the metal catalyst material may comprise a transition metal. For instance, the metal catalyst material may comprise a group VIIIB metal, as designated under the Chemical Abstracts Service (CAS) group number system. Group VIIIB metals include iron, ruthenium, osmium, cobalt, rhodium, iridium, nickel, palladium, and platinum. The metal catalyst material may comprise one or more of ruthenium, nickel, palladium, and platinum. The metal catalyst material may be a single type metal catalyst, containing mostly one metal material. The metal catalyst material may be a mixture or blend, containing more than one metal material. The mixture may be substantially homogeneous. The mixture may be heterogeneous.

The substrate may be in the form of particles or pellets. For example, the substrate may be in the form of pellets having an average diameter of less than 0.5 in, less than 0.25 in, or less than 0.15 in. In general, the substrate may have an average diameter of between 0.15-0.5 in or between 0.20-0.30 in. The substrate may be porous. The substrate pores may be sized to increase contact area of the metal catalyst material with the mixed liquor. Thus, the substrate may be a highly porous structure. The metal catalyst material may generally be provided as a fine coating on the highly porous substrate. The coating on the substrate may be substantially homogeneous. In other embodiments, the coating on the substrate may be heterogeneous.

The substrate material may be selected to be mechanically stable in high pH environments. The mixed liquor which comes into contact with the catalyst may have a pH greater than about 8.5, and in certain circumstances, approaching a high value of 14. The substrate may be formed of a material capable of withstanding such high pH environments without losing structural integrity or breaking down. For example, the substrate may be formed of a material which is mechanically stable at a pH of 8.5 or greater, for example, greater than 9, greater than 10, greater than 11, greater than 12, or greater than 13. In certain embodiments, the substrate may comprise a silica-type material. The substrate may comprise silica-type materials such as silica carbide, ceramic alumina, silica, and combinations thereof.

The metal-based catalyst may be replaced or regenerated after it becomes spent from use. As disclosed herein, the catalyst becomes spent when it no longer adequately catalyzes the conversion reaction of ammonia into nitrogen. One method for determining whether the metal-based catalyst is spent includes measuring ammonia concentration in the product or by product. Thus, the methods disclosed herein may comprise determining whether the metal-based catalyst is spent, or otherwise compromised, by measuring concentration of ammonia in the off gas and/or measuring concentration of ammonia in the liquid effluent. The catalyst may be replaced or regenerated responsive to the ammonia measurement being greater than a pre-determined threshold concentration value.

In certain embodiments, a concentration of ammonia in the liquid effluent greater than 500 ppm may indicate the catalyst has become spent or is improperly leaching ammonia into the product. The threshold concentration value of ammonia in the liquid effluent may be about 500 ppm, about 400 ppm, about 300 ppm, about 250 ppm, about 200 ppm, about 150 ppm, about 100 ppm, or about 50 ppm.

The threshold concentration of ammonia in the off gas may be determined by regulatory discharge limits. For example, the threshold concentration of ammonia in the off gas may be about 250 ppm, 200 ppm, 150 ppm, 100 ppm, 50 ppm, about 40 ppm, about 30 ppm, about 25 ppm, about 20 ppm, or about 10 ppm. In some embodiments, the threshold concentration of ammonia in the off gas may be determined by detection limits. For example, the threshold concentration of ammonia in the off gas may be about 50 ppb, about 40 ppb, about 30 ppb, about 20 ppb, about 10 ppb, about 8 ppb, about 6 ppb, about 4 ppb, or about 2 ppb.

The WAO system may comprise one or more sensor for measuring ammonia concentration in the gas and/or in the liquid effluent, positioned downstream from a gas outlet or liquid effluent outlet of the WAO unit. The sensor may be an ammonia gas detection sensor, for example, as manufactured and distributed by Sensidyne® (Schauenburg International GmbH, Müllheim, Germany). The sensor may be a dissolved ammonia monitor, for example, as manufactured and distributed by Analytical Technology, Inc. (Collegeville, Pa.). The sensor may be an ammonia selective ion electrode, for example, as manufactured and distributed by Grainger® (Lake Forest, Ill.). The one or more ammonia sensor (gas or liquid) may be any suitable sensor having an ammonia detection limit at or below the threshold concentration. The one or more ammonia sensor may be an on-line sensor. The one or more ammonia sensor may be configured to test a sample of gas or liquid effluent. The one or more ammonia sensor may be configured to alert a user responsive to measuring a concentration of ammonia in at least one of the gas and the liquid effluent greater than a pre-determined threshold concentration.

The system may comprise a controller operatively connected to at least one sensor, for example, to the ammonia sensor, a temperature sensor, a pressure sensor, a pH meter, and/or a flow meter. The controller may be a computer or mobile device. The controller may comprise a touch pad or other operating interface. For example, the controller may be operated through a keyboard, touch screen, track pad, and/or mouse. The controller may be configured to run software on any operating system. The controller may be electrically connected to a power source. The controller may be digitally connected to any one or more sensor. The controller may be connected to the sensor through a wireless connection. For example, the controller may be connected to the sensor through wireless local area networking (WLAN) or short-wavelength ultra-high frequency (UHF) radio waves.

In some embodiments, the controller may be configured to alert a user responsive to the ammonia sensor measuring a concentration of ammonia in at least one of the gas and the liquid effluent greater than a pre-determined threshold concentration. The controller may be configured to alert a user responsive to any sensor measuring a process parameter, for example, temperature, pressure, pH, and flow rate of a process fluid (for example, wastewater, oxidant, mixed liquor, liquid effluent, and/or off gas), exceeding a pre-determined threshold value.

The system may comprise one or more display unit. The display unit may be integrated with the sensor. The display unit may be integrated with the controller. The display unit may be operably connected to one or both of the sensor and the controller. In some embodiments, a mobile device may be operably connected to the system to operate as the display unit, for example, via a web browser or mobile application. The display unit may be configured to display measured concentration of ammonia. The display unit may be configured to display one or more process parameters. Thus, the display unit may be additionally or alternatively operably connected to a temperature sensor, pressure sensor, pH sensor, or flow meter. The display unit may be configured to visually alert a user of a process parameter or concentration of ammonia exceeding a pre-determined threshold value.

Additionally, existing WAO system may be retrofitted to operate as described herein. Methods of retrofitting a WAO unit or facilitating treatment of wastewater having organic nitrogen contaminants with a WAO unit are disclosed herein. The methods may include providing a metal-based catalyst and positioning the metal-based catalyst within a catalytic zone of the WAO unit. In certain embodiments, the methods may comprise designating an oxidation zone of the WAO unit and designating a catalytic zone of the WAO unit downstream from the designated oxidation zone. In some embodiments, designating the oxidation zone and catalytic zone may include installing a physical barrier between the oxidation zone and the catalytic zone. In other embodiments, designating the oxidation zone and the catalytic zone may not require installing a physical barrier. For instance, the oxidation zone and catalytic zone may be regions of the same WAO vessel.

In some embodiments, retrofitting an existing WAO system or facilitating treatment of wastewater as described herein may comprise providing a second vessel to operate as the catalytic zone. The methods may comprise fluidly connecting the catalytic vessel to a WAO oxidation vessel. The methods may comprise fluidly connecting the vessels, such that substantially all of the mixed liquor from the oxidation vessel is transferred to the catalytic vessel. For example, substantially all the mixed liquor may be transferred to the catalytic vessel by shutting any gas release valve of the oxidation vessel. The catalytic vessel may comprise a gas release valve configured to discharge the nitrogen containing gas. The methods may comprise fluidly connecting the catalytic vessel to a biological treatment unit or any other post-treatment unit for post-treatment of the liquid effluent. The methods may comprise instructing a user to operate the catalytic zone to convert ammonia in the mixed liquor to nitrogen, as previously described.

In some embodiments, the methods of retrofitting an existing WAO unit or facilitating treatment of the wastewater may comprise providing at least one sensor as described herein. The sensor may be a temperature sensor, pressure sensor, pH sensor, flow meter, and/or ammonia or other composition sensor. The methods may comprise providing a controller and/or display unit and operatively connecting the sensor to the controller or display unit, as previously described. The methods may comprise programming the controller to operate as previously described. For example, the controller may be programmed to alert a user responsive to a sensor measuring a parameter that exceeds a pre-determined threshold value.

In accordance with certain embodiments, the methods may comprise providing at least one ammonia sensor and positioning the at least one ammonia sensor downstream from at least one of the gas outlet and the liquid effluent outlet. The ammonia sensor may be programmed to operate as previously described. For example, the ammonia sensor may be programmed to alert a user responsive to measuring a concentration of ammonia in at least one of the gas and the liquid effluent greater than a pre-determined threshold concentration.

The methods may comprise providing one or more replacement metal-based catalysts. As previously described, the concentration of ammonia in the off gas or liquid effluent exceeding a threshold value may indicate that the metal-base catalyst in use is spent. Thus, the methods described herein may comprise replacing or regenerating the metal-based catalyst responsive to the concentration of ammonia in at least one of the gas and the liquid effluent being greater than the pre-determined threshold concentration.

In accordance with certain embodiments, the metal-based catalyst may be replaced periodically. The controller may be configured to monitor the parameters of wastewater treatment and predictively determine a schedule for replacement of the metal-based catalyst using historical data. The controller may inform the user to replace or regenerate the metal-based catalyst before or immediately before the metal-base catalyst becomes spent. Thus, the controller may anticipate the ammonia concentration exceeding the threshold value and alert the user prior to any ammonia leaching, to minimize disruptions and system downtime. In such embodiments, the controller may comprise a memory storing device or be operatively connected to a cloud storing device for storing historical performance data.

The methods of retrofitting an existing WAO unit or facilitating treatment of the wastewater may additionally comprise fluidly connecting an inlet of the WAO unit to a source of wastewater to be treated. In some embodiments, the methods may comprise instructing a user to fluidly connect the WAO unit to the source of wastewater. The methods may comprise instructing a user to operate the WAO unit to oxidize organic nitrogen contaminants to ammonia and convert ammonia in the mixed liquor to nitrogen, as previously described herein.

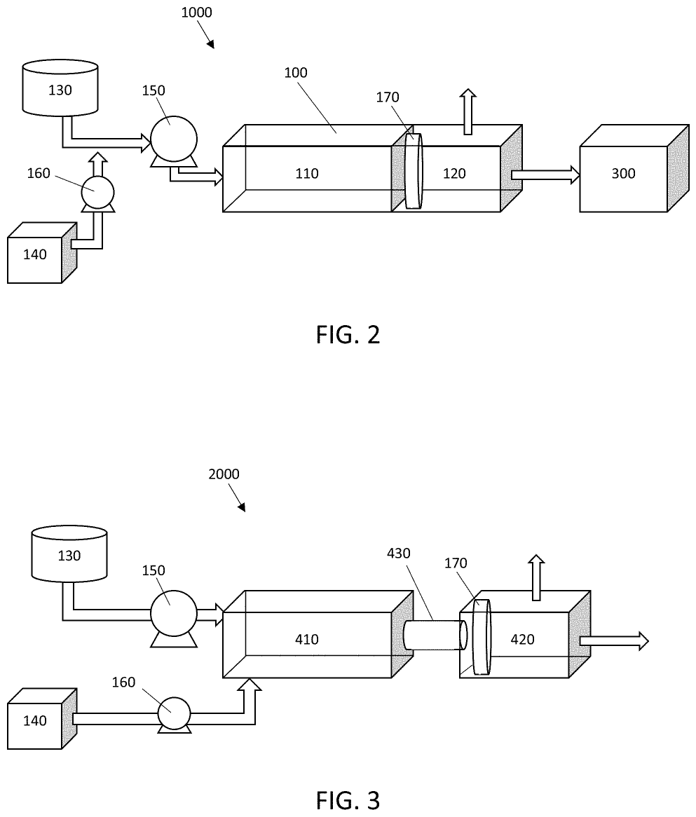

An exemplary WAO system is shown in FIG. 2. System 1000 of FIG. 2 includes a WAO unit 100 having an inlet fluidly connectable to a source of wastewater 130, a gas outlet, and a liquid effluent outlet. WAO unit 100 has oxidation zone 110 fluidly connectable to the source of an oxidant 140 and catalytic zone 120 downstream from the oxidation zone 110. WAO unit 100 includes a metal-based catalyst 170 positioned within the catalytic zone 120. A pump 150 is positioned to direct wastewater into the WAO unit 100. Oxidant injection pump 160 is positioned to direct oxidant into the wastewater. Liquid effluent may be directed to a post-treatment subsystem 300. Exemplary system 1000 is arranged such that wastewater and oxidant are combined and pressurized upstream from WAO unit 100. However, wastewater and oxidant may be combined in WAO unit 100, within the oxidation zone 110.

An alternate exemplary WAO system is shown in FIG. 3. The system 2000 of FIG. 3 is similar to system 1000, except that the catalytic zone 420 is positioned in a second vessel, fluidly connected downstream from the oxidation zone 410 vessel via conduit 430. Exemplary system 2000 is arranged such that wastewater and oxidant are combined in oxidation zone 410. However, wastewater and oxidant may be combined and pressurized upstream from the oxidation zone 410.

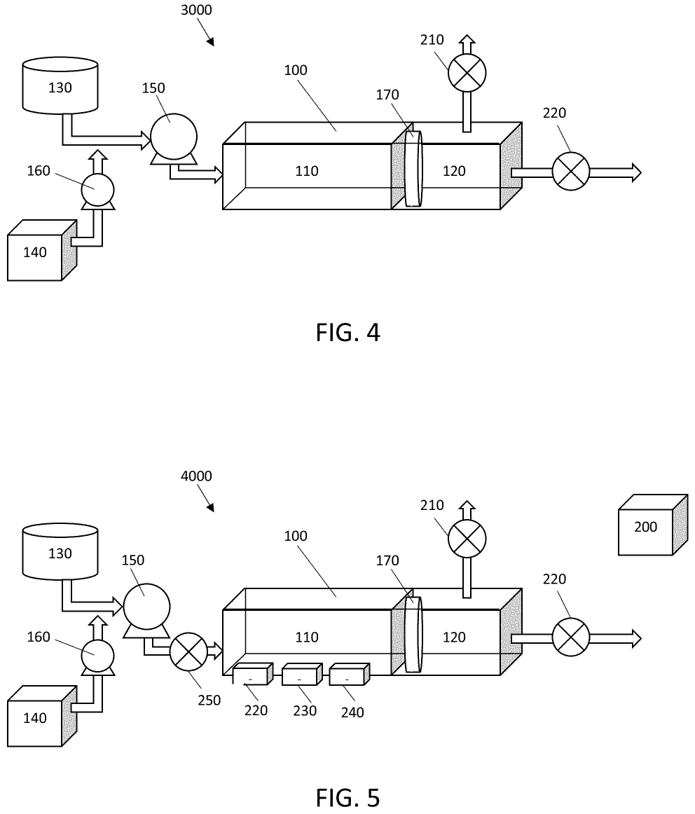

FIG. 4 is a schematic diagram of a system 3000 for treatment of wastewater containing organic nitrogen contaminants. System 3000 includes WAO unit 100 as shown in FIG. 2. However, the oxidation zone and catalytic zone may be arranged in separate vessels, as shown in FIG. 3. System 3000 includes ammonia sensor 210 positioned downstream from a gas outlet of the WAO unit 100 and ammonia sensor 212 positioned downstream from a liquid effluent outlet of the WAO unit 100. While exemplary system 3000 includes both ammonia sensors 210 and 212, the systems disclosed herein may include one of ammonia sensors 210 and 212.

FIG. 5 is a schematic diagram of a system 4000 for treatment of wastewater containing organic nitrogen contaminants. System 4000 includes WAO unit 100 as shown in FIG. 2. However, the oxidation zone and catalytic zone may be arranged in separate vessels, as shown in FIG. 3. System 4000 includes controller 200 operatively connected to one or more of ammonia sensors 210, 212. While exemplary system 4000 includes both ammonia sensors 210 and 212, the systems disclosed herein may include one of ammonia sensors 210 and 212.

System 4000 includes pH control subsystem 220 including a pH sensor. The pH control subsystem 220 may also include a pH adjuster (e.g., source of an acid and/or source of a base fluidly connected to the WAO unit 100). System 4000 includes temperature control subsystem 230 including a temperature sensor. Temperature control subsystem 230 may also include a temperature adjustment mechanism (e.g., heat exchanger). System 4000 includes pressure control subsystem 240 including a pressure sensor. Pressure control subsystem 240 may also include a pressure adjustment mechanism (e.g., pressure control valve). System 4000 includes flow control subsystem 250 including a flow meter. Flow control subsystem 250 may also include a flow adjustment mechanism (e.g., pump or valve). The pH control subsystem 220, temperature control subsystem 230, pressure control subsystem 240, and flow control subsystem 250 are operatively connected to controller 200. Any combination of one or more control subsystem may be operatively connected to the controller 200.

### EXAMPLES

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

### Example 1: Bench-Scale Treatment of Water Containing Organic Nitrogen Compounds

A bench-scale wet air oxidation treatment of contaminated solutions was performed to test the methods disclosed herein. Two sample spent caustic solutions were tested: one containing urea and one containing monoethanolamine (MEA) as the exemplary organic nitrogen compounds. The samples were oxidized and then treated with catalyst. Total Kjeldahl nitrogen (TKN) and nitrates/nitrites were measured in the liquid effluent. Nitrogen and other compounds were measured in the off gas.

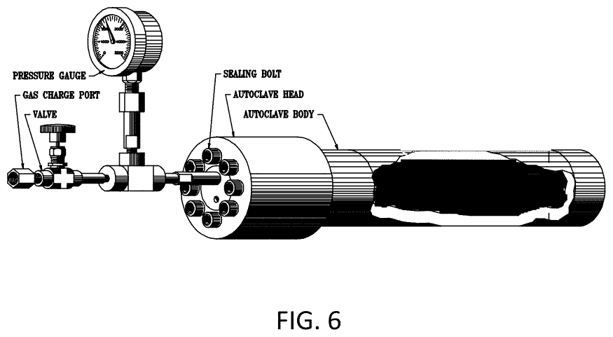

The wet air oxidation was performed in a series of laboratory shaking autoclaves, as shown in FIG. 6. Briefly, a sample of wastewater was added to an autoclave. Multiple autoclaves per condition were used at each test condition to obtain a sufficient quantity of oxidized effluent for the required analytical test and to mitigate variations that may occur at any one condition. For the catalytic hydrolysis tests, a catalyst basket was added to the autoclave. The autoclaves were then closed and pressurized with either compressed nitrogen or compressed air. For the oxidation conditions, enough air was added to maintain sufficient residual oxygen. For the catalytic hydrolysis conditions, the autoclave was purged multiple times with nitrogen and then pressurized with nitrogen.

The charged autoclaves were placed into the heater/shaker mechanism and heated to the desired temperature. The autoclaves were held at temperature for a specific length of time and then were immediately removed and cooled to room temperature using tap water to quench the reaction. After cooling, the final pressure in the autoclave was measured. The off gas was analyzed for oxygen, nitrogen, carbon monoxide, carbon dioxide, hydrogen, methane and total volatile organic compounds using gas chromatograph procedures. After the autoclave was depressurized, the autoclave was opened, and the treated effluent was removed and retained for effluent characterization.

The process parameters and results are summarized in Tables 1-2.

TABLE 1
Bench-Scale Test Parameters and Results
for Urea-Containing Samples

| | | | | | |
|---|---|---|---|---|---|
| Sample | 1 | 2 | 3 | 4 | 5 |

Charge Conditions

| | | | | | |
|---|---|---|---|---|---|
| Oxidation | — | 200 | 200 | 260 | 260 |
| Temperature | | | | | |
| (° C.) | | | | | |
| Time at | — | 60 | 60 | 60 | 60 |
| Temperature | | | | | |
| (min) | | | | | |
| Catalyst | — | 15 | 15 | 15 | 15 |
| Dose | | | | | |
| (g/autoclave) | | | | | |
| Catalyst | — | Ni | Ru | Ni | Ru |
| Type | | | | | |
| Autoclave | — | SS | SS | SS | SS |
| Catalyst | | | | | |
| Support | | | | | |
| Autoclave | — | Ni200 | Ni200 | Ni200 | Ni200 |
| Material | | | | | |
| Autoclave | — | 500 | 500 | 500 | 500 |
| Volume | | | | | |
| (mL) | | | | | |
| Volume of | — | 100 | 100 | 100 | 100 |
| Liquid | | | | | |
| Charged | | | | | |
| (mL) | | | | | |
| Air Charged | — | 650 | 650 | 650 | 650 |
| (psig) | | | | | |
| Barometric | — | 726 | 726 | 726 | 726 |
| Pressure | | | | | |
| (mm Hg) | | | | | |
| Charge Gas | — | 74 | 74 | 74 | 74 |
| Temperature | | | | | |
| (° C.) | | | | | |

Liquid Effluent Data

| | | | | | |
|---|---|---|---|---|---|
| TKN | 2000 | 1620 | 321 | 1790 | ND |
| (mg/L N) | | | | | |
| TKN | — | 19.0% | 84.0% | 10.5% | 100.0% |
| Destruction | | | | | |
| (%) | | | | | |
| Nitrates/ | ND | 3.6 | 282 | 8.6 | 1450 |
| Nitrites | | | | | |
| (mg/L N) | | | | | |
| TOC (mg/L | 2070 | 964 | 1010 | 984 | 934 |
| C) | | | | | |
| pH | 13.6 | 13.3 | 13.0 | 13.4 | 12.1 |

Off Gas Data

| | | | | | |
|---|---|---|---|---|---|
| Pressure | — | 510 | 496 | — | 486 |
| (psig) | | | | | |
| Temperature | — | 21.8 | 19.0 | 17.5 | 17.7 |
| (° C.) | | | | | |
| Carbon | — | <0.1 | <0.1 | <0.1 | <0.1 |
| Monoxide | | | | | |
| (% CO) | | | | | |
| Carbon | — | <0.5 | <0.5 | <0.5 | <0.5 |
| Dioxide | | | | | |
| (% CO₂) | | | | | |
| Oxygen | — | 3.3 | 4.5 | 5.6 | 2.4 |
| (% O₂) | | | | | |
| Nitrogen | — | 90.2 | 88.8 | 88.7 | 92.2 |
| (% N₂) | | | | | |
| Hydrogen | — | 0.28 | 0.10 | 0.27 | 0.11 |
| (% H₂) | | | | | |
| Methane | — | <50 | <50 | 35 | <50 |
| (ppm CH₄) | | | | | |
| THC (ppm | — | 57 | 4 | 83 | 4 |
| CH₃CH₄) | | | | | |

TABLE 2
Bench-Scale Test Parameters and Results
for MEA-Containing Samples

| | | | | | |
|---|---|---|---|---|---|
| Sample | 1 | 2 | 3 | 4 | 5 |

Charge Conditions

| | | | | | |
|---|---|---|---|---|---|
| Oxidation | — | 200 | 200 | 260 | 260 |
| Temperature | | | | | |
| (° C.) | | | | | |
| Time at | — | 60 | 60 | 60 | 60 |
| Temperature | | | | | |
| (min) | | | | | |
| Catalyst | — | 15 | 15 | 15 | 15 |
| Dose | | | | | |
| (g/autoclave) | | | | | |
| Catalyst | — | Ni | Ru | Ni | Ru |
| Type | | | | | |
| Autoclave | — | SS | SS | SS | SS |
| Catalyst | | | | | |
| Support | | | | | |
| Autoclave | — | Ni200 | Ni200 | Ni200 | Ni200 |
| Material | | | | | |
| Autoclave | — | 500 | 500 | 500 | 500 |
| Volume | | | | | |
| (mL) | | | | | |
| Volume of | — | 100 | 100 | 100 | 100 |
| Liquid | | | | | |
| Charged | | | | | |
| (mL) | | | | | |
| Air Charged | — | 750 | 750 | 750 | 750 |
| (psig) | | | | | |
| Barometric | — | 725 | 725 | 725 | 725 |
| Pressure | | | | | |
| (mm Hg) | | | | | |
| Charge Gas | — | 71 | 71 | 71 | 71 |
| Temperature | | | | | |
| (° C.) | | | | | |

Liquid Effluent Data

| | | | | | |
|---|---|---|---|---|---|
| TKN | 1940 | 1660 | 83 | 127 | 376 |
| (mg/L N) | | | | | |
| TKN | | 14.4% | 95.7% | 93.5% | 80.6% |
| Destruction | | | | | |
| (%) | | | | | |
| Nitrates/ | ND | 4.1 | 37.6 | 3.4 | 634 |
| Nitrites | | | | | |
| (mg/L N) | | | | | |
| TOC (mg/L | 4340 | 3810 | 3830 | 2390 | 1380 |
| C) | | | | | |
| pH | 13.6 | 13.3 | 12.4 | 13.3 | 11.3 |

Off Gas Data

| | | | | | |
|---|---|---|---|---|---|
| Pressure | — | 623 | 604 | 570 | 557 |
| (psig) | | | | | |
| Temperature | — | 20.5 | 25.1 | 18.3 | 19.8 |
| (° C.) | | | | | |
| Carbon | — | <0.1 | <0.1 | <0.1 | <0.1 |
| Monoxide | | | | | |
| (% CO) | | | | | |
| Carbon | — | <0.5 | <0.5 | <0.5 | <0.5 |
| Dioxide | | | | | |
| (% CO₂) | | | | | |
| Oxygen | — | 5.7 | 5.9 | 0.9* | 1.1* |
| (% O₂) | | | | | |
| Nitrogen | — | 87.7 | 87.9 | 92.0 | 92.5 |
| (% N₂) | | | | | |
| Hydrogen | — | 0.34 | 0.15 | 0.67 | 0.20 |
| (% H₂) | | | | | |
| Methane | — | <50 | <50 | <50 | <50 |
| (ppm CH₄) | | | | | |
| THC (ppm | — | 59 | <10 | 55 | 8 |
| CH₃CH₄) | | | | | |

*Test run ran out of O₂

Thus, the catalyst was effective for destroying TKN in the liquid effluent and converting ammonia to nitrogen in the off gas. While only ruthenium and nickel catalysts were tested, it is expected that all group VIIIB metal catalysts will exhibit similar results.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described several aspects of at least one embodiment, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure and are intended to be within the scope of the invention. Accordingly, the foregoing description and drawings are by way of example only.

Those skilled in the art should appreciate that the parameters and configurations described herein are exemplary and that actual parameters and/or configurations will depend on the specific application in which the disclosed methods and materials are used. Those skilled in the art should also recognize or be able to ascertain, using no more than routine experimentation, equivalents to the specific embodiments disclosed.

Certain embodiments are within the scope of the following claims.

1. A system for treating wastewater containing organic nitrogen compounds, comprising:
a wet air oxidation unit having an inlet fluidly connectable to a source of the wastewater containing organic nitrogen compounds, a gas outlet, and a liquid effluent outlet, the wet air oxidation unit comprising:
an oxidation zone fluidly connectable to a source of an oxidant;
a catalytic zone downstream from the oxidation zone; and
a metal-based catalyst configured to catalyze a conversion reaction of ammonia to nitrogen, positioned within the catalytic zone.

2. The system of claim 1, further comprising at least one ammonia sensor positioned downstream from at least one of the gas outlet and the liquid effluent outlet.

3. The system of claim 1, wherein the metal-based catalyst comprises a porous substrate coated with a group VIIIB metal.

4. The system of claim 3, wherein the group VIIIB metal is at least one of ruthenium, nickel, palladium, and platinum.

5. The system of claim 3, wherein the porous substrate is mechanically stable at a pH of 8.5 or greater.

6. The system of claim 5, wherein the porous substrate comprises a silica-type material.

7. The system of claim 1, wherein a volume of the oxidation zone is at least about twice a volume of the catalytic zone.

8. The system of claim 7, wherein the oxidation zone and the catalytic zone are within a single vessel.

9. The system of claim 7, wherein the oxidation zone is within a first vessel and the catalytic zone is within a second vessel fluidly connected to the first vessel.

10. The system of claim 1, wherein the wastewater containing organic nitrogen compounds is a spent caustic solution.

11. The system of claim 10, wherein the spent caustic solution is a refinery spent caustic solution.

12. A method of treating wastewater containing organic nitrogen compounds, comprising:
contacting the wastewater with an oxidant to oxidize a target percentage of the organic nitrogen compounds and produce a mixed liquor comprising ammonia;
contacting the mixed liquor with a metal-based catalyst to convert a target percentage of the ammonia to nitrogen and produce a gas comprising nitrogen and
a liquid effluent comprising nitrogen; and
releasing the gas comprising nitrogen.

13. The method of claim 12, further comprising measuring at least one of a concentration of ammonia in the gas and a concentration of ammonia in the liquid effluent.

14. The method of claim 13, further comprising replacing or regenerating the metal-based catalyst responsive to the measurement of ammonia in at least one of the gas and the liquid effluent being greater than a pre-determined threshold concentration.

15. The method of claim 14, wherein the threshold concentration of ammonia in the liquid effluent is less than 300 ppm and the threshold concentration of ammonia in the gas is less than 250 ppm.

16. The method of claim 12, wherein the target percentage of the ammonia to be converted is at least 95%.

17. The method of claim 12, further comprising measuring a pH value of the mixed liquor.

18. The method of claim 12, further comprising directing the liquid effluent to a biological treatment operation.

19. A method of retrofitting a wet air oxidation unit having an inlet fluidly connected to a source of a wastewater containing organic nitrogen compounds, a gas outlet, and a liquid effluent outlet, the method comprising:
designating an oxidation zone of the wet air oxidation unit, fluidly connected to a source of an oxidant;
designating a catalytic zone of the wet air oxidation unit downstream from the oxidation zone;
providing a metal-based catalyst configured to catalyze a conversion reaction of ammonia to nitrogen; and
positioning the metal-based catalyst within the catalytic zone.

20. The method of claim 19, comprising providing a vessel to be designated as the catalytic zone and fluidly connecting the vessel to the oxidation zone.

21. The method of claim 19, further comprising providing at least one ammonia sensor and positioning the at least one ammonia sensor downstream from at least one of the gas outlet and the liquid effluent outlet.

22. The method of claim 21, further comprising programming the sensor or a controller operably connected to the sensor to alert a user responsive to measuring a concentration of ammonia in at least one of the gas and the liquid effluent greater than a pre-determined threshold concentration.

23. The method of claim 22, wherein the threshold concentration of ammonia in the liquid effluent is less than 300 ppm, and the threshold concentration of ammonia in the gas is less than 250 ppm.

24-31. (canceled)
